(19) United States
(12) Patent Application Publication
(10) Pub. No.: US 2012/0101915 A1
(43) Pub. Date: Apr. 26, 2012

(54) COMMISSION BASED SALE ON E-COMMERCE

(76) Inventor: Yanchao Fu, Shanghai (CN)

(21) Appl. No.: 13/132,017

(22) PCT Filed: Dec. 11, 2008
(86) PCT No.: PCT/CN2008/001991

§ 371 Date: Jan. 3, 2012

(51) Int. Cl. G06Q 30/06; G06F 17/30

(52) U.S. Cl. 705/26.41

(57) ABSTRACT

One embodiment provides a method for facilitating a seller of a product to sell the product. The method includes accessing information retrieved from a search query conducted by a potential buyer for the product. The buyer information of the potential buyer is extracted form the accessed information. The buyer information includes, for example, contact and interest information of the potential buyer. Thereafter, the buyer information of the potential buyer is transmitted to a third party. In turn, a compensation for the product is received from the potential buyer, in which the compensation identifies the third party as a promoter of the product. A commission is then transferred to the third party in response to the received compensation for the product from the potential buyer.

### TECHNICAL FIELD

The present application relates to methods and systems for conducting electronic commerce activities over a network.

### BACKGROUND

With the development of computer and network related technologies, more users communicate over networks and participate in electronic commerce activities, e.g. selling/buying products, or bidding on items over networks. However, in many situations, it is a challenging task for sellers of products to efficiently and successfully sell their products to potential buyers.

### BRIEF DESCRIPTION OF DRAWINGS

The present disclosure is illustrated by way of example and not limitation in the figures of the accompanying drawings, in which like references indicate similar elements and in which:

FIG. 1 is an overview diagram illustrating a network system configured to sell a product to a potential buyer via a third party over a network according to an example embodiment;

FIG. 2 is an overview diagram illustrating in more detail the network system as shown in FIG. 1 configured to sell a product to a potential buyer via a third party over a network according to an example embodiment;

FIG. 3 is a simplified block diagram illustrating modules included in a seller system within the network system according to an example embodiment;

FIG. 4 is a flowchart illustrating a method of selling a product to a potential buyer via a third party over a network according to an example embodiment;

FIG. 5 is a flowchart illustrating a method of selling a product to a potential buyer via a third party over a network according to another example embodiment; and

FIG. 6 is a block diagram illustrating a machine in an example form of a computer system, within which a set of sequence of instructions for causing the machine to perform any one of the methodologies discussed herein may be executed.

### DETAILED DESCRIPTION

In the following description, for purposes of explanation, numerous specific details are set forth in order to provide a thorough understanding of example embodiments. It will be evident, however, to one skilled in the art that the embodiments of the application may be practiced without these specific details. Embodiments for selling a product of a seller to a potential buyer via a third party over a network are described. For example, a seller system of a product may access information retrieved from a search query conducted by a potential buyer for the product, and extract buyer information of the potential buyer from the accessed information, which may include contact and interest information of the potential buyer. The seller system may then transmit the buyer information of the potential buyer to a third party, who may promote the product to the potential buyer based on the buyer information transmitted from the seller system. If the promotion of the product by the third party to the potential buyer is successful, the seller system may receive a compensation for the product from the potential buyer, in which the compensation may identify the third party as the promoter of the product. Then, in response to the received compensation for the product from the potential buyer, the seller system of the product may transfer a commission to the third party.

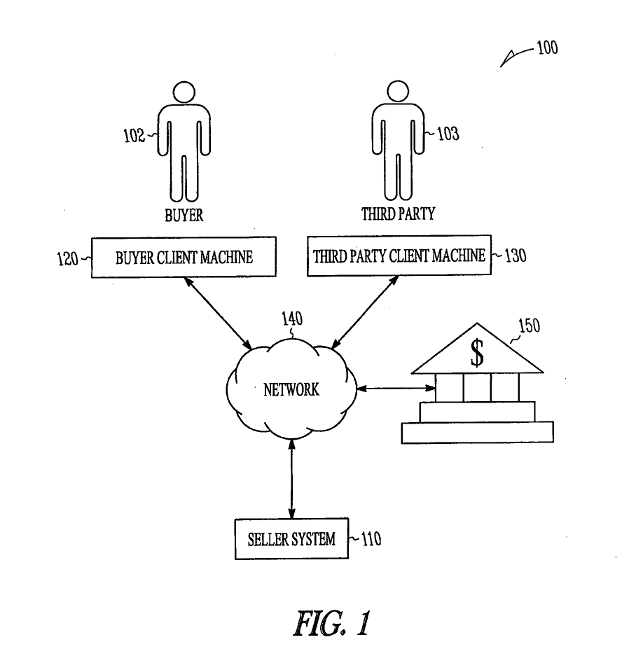

FIG. 1 is an overview diagram illustrating a network system 100 to sell a product to a potential buyer 102 via a third party 103 over a network 140 according to an example embodiment. The term “product” denotes either a physical product or a service provided by the seller. For example, a product can be a physical product, such as a vehicle and a laptop computer, and can also be a service, such as a life insurance program and a long distance phone call plan. The network system 100 may include a seller system 110, a buyer client machine 120, and a third party client machine 130, which are all coupled to the network 140. The third party 103 is an entity or an individual other than the seller and the potential buyer 102 of the product. The third party 103 may have a business relationship with the seller of the product, and may help the seller of the product to promote the product. The seller system 110, the buyer client machine 120, and/or the third party client machine 130 may optionally be in communication with a banking system 150 via the network 140.

In some embodiments, the seller system 110 of a product may obtain buyer information of a potential buyer 102 (e.g., who intends to buy a vehicle). The buyer information is information or data related to the potential buyer 102, and may include contact information (e.g., email address, post address, and phone number) and interest information (e.g., the preference of a specific make and model of the vehicle) of the potential buyer 102. For example, the buyer information may be retrieved directly from a search query entered by a potential buyer 102 for a product. The search query denotes a query that a user enters into a web search engine to satisfy his or her information needs. Examples of queries include a variety of words, sentences, and alphanumeric characters, such as “Toyota,” “Camry,” and “2005.” The seller system 110 of the product (e.g., Toyota®, Camry®) may in turn transmit the buyer information of the potential buyer 102 to a third party 103, who may help to promote the product to the potential buyer 102 based on the buyer information transmitted from the seller system 110. If the promotion of the product by the third party 103 to the potential buyer 102 is successful, the seller system 110 of the product may then transfer a commission to the third party 103. The commission is a compensation as reward or remuneration to the third party 103 for the successful promotion service rendered by the third party 103.

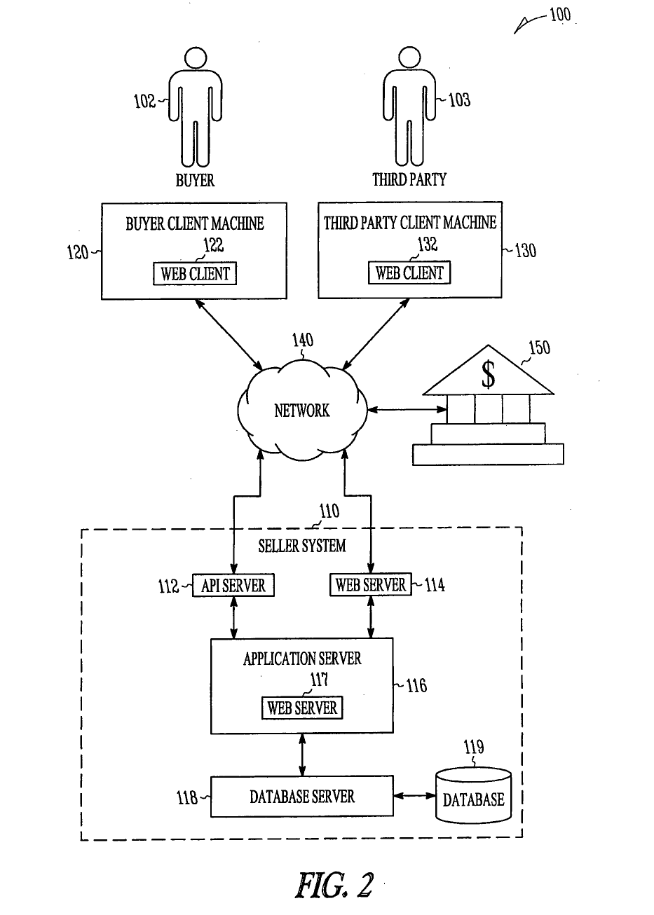

FIG. 2 is an overview diagram illustrating in more detail the network system 100 as shown in FIG. 1 configured to sell a product to a potential buyer 102 via a third party 103 over a network 140 according to an example embodiment. As depicted in FIG. 2, the seller system 110 of the network system 100 may include an application server 116, an application program interface (API) server 112, and a web server 114. The API server 112 and the web server 114 are coupled to the application server 116 and provide programmatic interface and web interface to the application server 116. The application server 116 includes a number of modules 117 (as shown in FIG. 2), and is coupled to one or more database servers 118 that facilitate access to one or more databases 119. It should be noted that FIG. 2, as well as FIG. 1, depicts a client-server architecture. The term “client-server” denotes a model of interaction in a distributed computer system in which a program at one site sends a request to a program at another site and waits for a response. The requesting program is called the “client,” and the program that responds to the request is called the “server.”

The seller system 110 may form a platform, which may receive or transmit information or items (e.g., data, compensation, and commission) from one or more clients, and may also provide server-side functionalities to one or more clients over the network 140. The information or items transmitted and/or received by the seller system 110 may include, but is not limited to, a search query conducted by a potential buyer 102 for a product of a seller, buyer information (including contact and interest information) of the potential buyer 102, compensation for the product from the potential buyer 102, and commission paid from the seller system 110 of the product to a third party 103 who successfully promotes the product to the potential buyer 102.

In some embodiments, the seller system 110 of the product (e.g., a pickup truck dealer) may access information retrieved from a search query for the product entered by a potential buyer 102. For example, the potential buyer 102 may access the buyer client machine 120, which may include a web client application 122, to conduct a product search by entering a search query.

The seller system 110 may extract buyer information of the potential buyer 102 from the accessed information. The seller system 110 may store the buyer information of the potential buyer 102 in a data storage in the database 119 of the seller system 110. The seller system 110 may then use the API server 112 and the web server 114 to transmit the buyer information of the potential buyer 102 to a third party 103.

The third party 103 may promote the product of the seller to the potential buyer 102 based on the buyer information provided from the seller system 110 of the product. For example, the third party 103 may access the third party client machine 130, which may include a web client application 132, to conduct the promotion. The promotion of the product may be conducted via the seller system 110, or by other methods that will be apparent to those skilled in the art, such as via phone call, Skype, email, mail, or fax.

In some embodiments, if the promotion of the product by the third party 103 to the potential buyer 102 is successful, the seller system 110 of the product would receive a compensation for the product from the potential buyer 102. The compensation received from the buyer 102 may identify the third party 102 as the successful promoter of the product to the buyer 102. The compensation information may be stored in a data storage in the database 119 of the seller system 110.

In some embodiments, in response to the received compensation for the product from the potential buyer 102, the seller system 110 of the product may transfer a commission to the third party 103 as a reward for his successful promotion of the product to the buyer 102.

While the network system 100 as shown in FIGS. 1 and 2 employs a client-server architecture, embodiments of the present application are not limited to such an architecture, and could equally well find application in other kinds of architectures, for example, a distributed architecture or a peer-to-peer architecture.

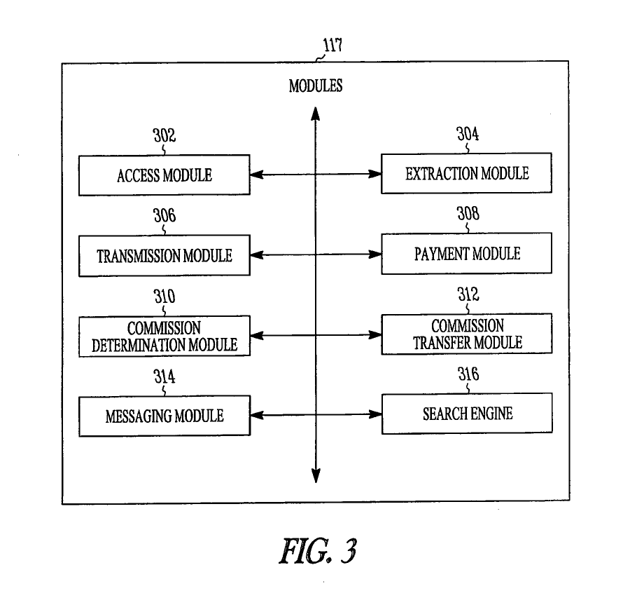

FIG. 3 is a simplified block diagram illustrating modules 117 included in the application server 116 of the seller system 110 in accordance with an example embodiment. The application server 116 may provide a number of modules 117, which provide functions and services to users of the seller system 110. For example, the modules 117 may include, but are not limited to, an access module 302, an extraction module 304, a transmission module 306, a compensation module 308, a commission determination module 310, a commission transfer module 312, a messaging module 314, and a search engine 316.

In some embodiments, by using the search engine 316 for example, the access module 302 of the application server 116 may access information retrieved from a search query conducted by a potential buyer 102 for a product.

In some embodiments, the extraction module 304 of the application server 116 may extract buyer information of the potential buyer 102 from the accessed information, in which the buyer information may include contact information and interest information of the potential buyer 102.

In some embodiments, the transmission module 306 of the application server 116 may transmit the extracted buyer information of the potential buyer 102 to the third party 103. The third party 103 may be an individual or entity for example selected by the seller of the product, and may contact the potential buyer 102 to promote the product based on the contact and interest information of the potential buyer 102.

In some embodiments, the compensation module 308 of the application server 116 may receive a compensation for the product from the potential buyer 102. The received compensation by the compensation module 306 may, for example, identify the third party 103 as the promoter of the product.

In some embodiments, the commission determination module 310 of the application server 116 may determine the price of the commission paid to the third party 103 for the promotion of the product to the potential buyer 102. In an embodiment, the price of the commission may be determined based on the value of the product, which is promoted by the third party 103 to the buyer 102. In another embodiment, the price of the commission may be determined based on the number of the products, which are promoted by the third party 103 to the buyer 102.

In still another embodiment, the price of the commission may be determined based on the reputation of the third party 103. For example, the reputation of the third party 103 may be evaluated based on historical promotion data of the third party 103, such as the total number and value of past successful promotions by the third party 103. If the rank of the reputation of the third party 103 is relatively higher, the rate of the commission for the third party 103 may be relatively higher.

In some embodiments, the commission transfer module 312 of the application server 116 may transfer the commission to the third party 103 in response to the received compensation for the product from the potential buyer 102. In an embodiment, the commission from the seller system 110 to the third party 103 may be transferred by crediting an account of the third party 103 in the banking system 150 with an amount of the commission. In another amendment, the commission from the seller system 110 to the third party 103 may be transferred by debiting an account of the seller of the product in the banking system 150 with an amount of the commission.

In some embodiments, the messaging module 314 of the application server 116 may be used to deliver messages among users (for example, the seller of the product, the potential buyer 102, and the third party 103) of the network system 100. For example, the messaging module 314 may be used by the seller system 110 to send a message to the potential buyer 102 to acknowledge the receipt of the compensation from the potential buyer 102 for the product. The messaging module 314 may be used by the third party 103 to send a message to the seller system 110 to acknowledge the receipt of the commission, which has been transferred from the seller system 110.

FIG. 4 is a flowchart illustrating a general overview of a method 400 of selling a product to a potential buyer 102 via a third party 103 over a network 140 in accordance with an example embodiment.

First, buyer information of a potential buyer 102 is obtained by a seller system 110 at 402. For example, the buyer information may include contact information and interest information of the potential buyer 102.

Then, the buyer information of the potential buyer 102 is transmitted at 404 to a third party 103, who may help to promote the product to the potential buyer 102 based on the obtained buyer information.

Later, a compensation for the product from the potential buyer 102 is received at 406, if the promotion of the product via the third party 103 is successful. For example, the potential buyer 102 may finally buy the product due to the promotion effort of the third party 103, and may send the compensation for the product to the seller system 110 of the product, in which the compensation may identify the third party 103 as the promoter of the product.

At last, in response to the received compensation for the product from the potential buyer 102, a commission is transferred at 408 from the seller system 110 to the third party 103, who successfully promotes the product to the potential buyer 102.

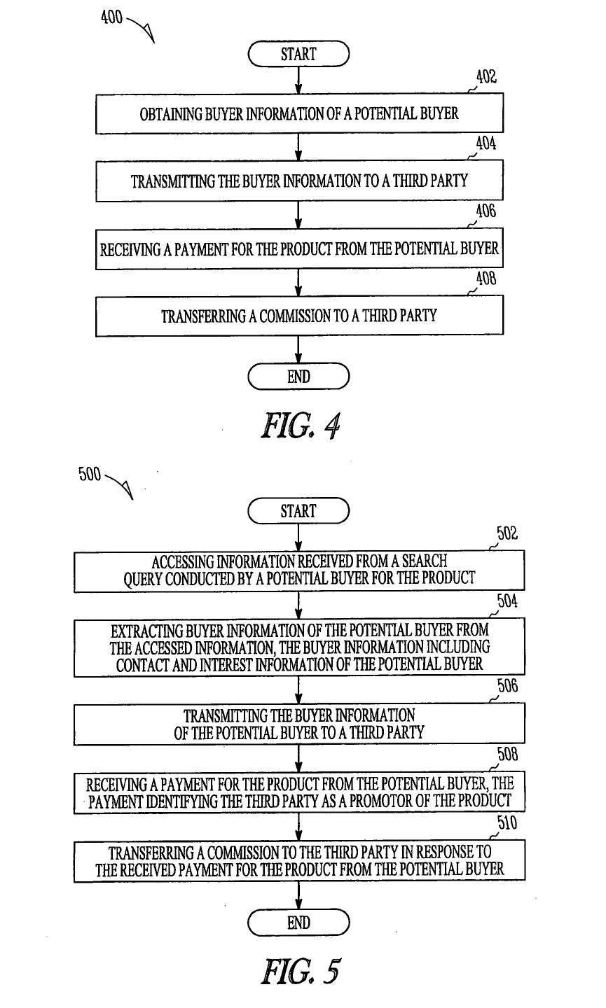

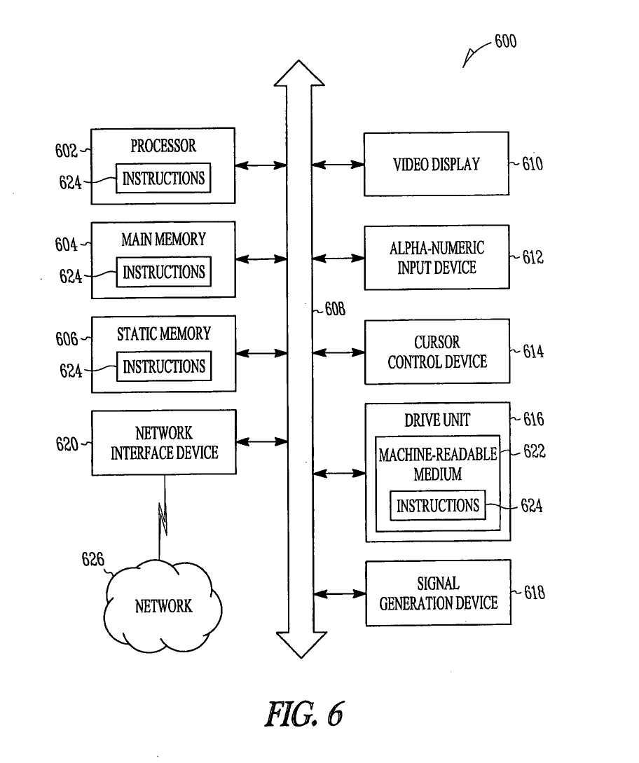

FIG. 5 is a flowchart illustrating a method 500 of selling a product to a potential buyer 102 via a third party 103 over a network 140 in accordance with another example embodiment.

At 502 of the embodiment, information retrieved from a search query conducted by a potential buyer 102 for a product is accessed by a seller system 110 of the product.

At 504, buyer information of the potential buyer 102 is extracted from the accessed information, in which the buyer information may include contact information and interest information of the potential buyer 102. The buyer information of the potential buyer may be stored in a data storage (for example, a table) in the database 119 of the seller system 110.

At 506, the buyer information of the potential buyer 102 is transmitted to a third party 103, who may help to promote the product to the potential buyer 102 based on the buyer information received from the seller system 110 of the product. In some embodiments, information relating to the price of the commission for promoting the product is also transmitted to the third party 103 along with the buyer information.

At 508, a compensation for the product from the potential buyer 102 is received, if the promotion of the product of the seller via the third party 103 is successful. For example, the potential buyer 102 may finally buy the product of seller due to the promotion effort of the third party 103, and may send the compensation for the product to the seller system 110 of the product, in which the compensation may identify the third party 103 as the promoter of the product. The compensation information of the compensation from the potential buyer 102 may be stored in a data storage (for example, a table) in the database 119 of the seller system 110.

At 510, in response to the received compensation for the product from the potential buyer 102, a commission is transferred from the seller system 110 of the product to the third party 103, who successfully promotes the product to the potential buyer 102.

In an embodiment, the price of the commission may be determined based on the value of the product, which is promoted by the third party 103 to the buyer 102. In another embodiment, the price of the commission may be determined based on the number of the products, which are promoted by the third party 103 to the buyer 102. In still another embodiment, the price of the commission may be determined based on the reputation of the third party 103. The reputation of the third party 103 may be evaluated based on historical promotion data of the third party 103, for example, the total number and/or value of past successful promotions by the third party 103. If the rank of the reputation of the third party 103 is relatively higher, the rate of the commission for the third party 103 may be relatively higher.

In an embodiment, the commission from the seller of the product to the third party 103 may be transferred by crediting an account of the third party 103 in the banking system 150 with an amount of the commission. In another amendment, the commission from the seller of the product to the third party 103 may be transferred by debiting an account of the seller of the product in the banking system 150 with an amount of the commission.

In some embodiments, the seller of the product may receive an acknowledge from the third party 103 to confirm the receipt of the commission. The acknowledge of the receipt of the commission may be stored in a data storage in the database 119 of the seller system 110.

FIG. 6 is a block diagram illustrating a machine in the example form of a computer system 400, within which a set of sequence of instructions for causing the machine to perform any one of the methodologies discussed herein may be executed. In alternative embodiments, the machine may be a server computer, a client computer, a personal computer (PC), a tablet PC, a set-top box (STB), a Personal Digital Assistant (PDA), a cellular telephone, a web appliance, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The example computer system 600 includes a processor 602 (e.g., a central processing unit (CPU) a graphics processing unit (GPU) or both), a main memory 604 and a static memory 406, which communicate with each other via a bus 608. The computer system 400 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media.

Thus, methods and systems for remittance delivery from a first party to a third party through an intermediary party have been described. Although the present invention has been described with reference to specific embodiments, it will be evident that various modifications and changes may be made to these embodiments without departing from the broader spirit and scope of the invention. Accordingly, the specification and drawings are to be regarded in an illustrative rather than a restrictive sense.

1. A computerized method comprising:
accessing information retrieved from a search query conducted by a potential buyer for a product;
extracting buyer information of the potential buyer from the accessed information, the buyer information including contact and interest information of the potential buyer;
transmitting the buyer information of the potential buyer to a third party;
receiving a compensation for the product from the potential buyer, the compensation identifying the third party as a promoter of the product; and
transferring a commission to the third party in response to the received compensation for the product from the potential buyer.

2. The computerized method of claim 1, further comprising transmitting information relating to a price of the commission with the buyer information to the third party.

3. The computerized method of claim 2, wherein the price of the commission is based on a value of the product.

4. The computerized method of claim 2, wherein the price of the commission is based on a reputation of the third party.

5. The computerized method of claim 1, wherein the buyer information is retrieved from the search query.

6. The computerized method of claim 1, wherein the transferring of the commission to the third party comprises crediting an account of the third party with the commission.

7. The computerized method of claim 1, wherein the transferring of the commission to the third party comprises debiting an account of a seller of the product with the commission.

8. The computerized method of claim 1, further comprising receiving a confirmation of the transferring of the commission from the third party.

9. A system comprising:
an extraction module to extract buyer information of a potential buyer from information retrieved from a search query conducted by the potential buyer for a product, wherein the buyer information includes contact and interest information of the potential buyer;
a transmission module to transmit the buyer information of the potential buyer to a third party;
a compensation module to receive a compensation for the product from the buyer, wherein the received compensation identifies the third party as a promoter of the product; and
a commission transfer module to transfer a commission to the third party in response to the received compensation for the product from the buyer.

10. The system of claim 9, further comprising:
an access module to access the information retrieved from the search query conducted by the potential buyer for the product.

11. The system of claim 9, further comprising:
a commission determination module to determine a price of the commission to the third party.

12. The system of claim 11, wherein the price of the commission is determined by the commission determination module based on a value of the product.

13. The system of claim 11, wherein the price of the commission is determines by the commission determination module based on a reputation of the third party.

14. The system of claim 9, further comprising:
a first storage to store the buyer information of the potential buyer; and
a second storage to store information of the compensation from the potential buyer for the product.

15. A machine-readable medium comprising instructions, which when implemented by one or more processors, perform the following operations:
accessing information retrieved from a search query conducted by a potential buyer for the product;
extracting buyer information of the potential buyer from the accessed information, the buyer information including contact and interest information of the potential buyer;
transmitting the buyer information of the potential buyer to a third party;
receiving a compensation for the product from the buyer, the compensation identifying the third party as a promoter of the product; and
transferring a commission to the third party in response to the received compensation for the product from the buyer.

16. The machine-readable medium of claim 15, further comprising instructions, which when implemented by one or more processors, perform the following operations:
storing the buyer information of the potential buyer in a storage.

17. The machine-readable medium of claim 15, further comprising instructions, which when implemented by one or more processors, perform the following operations:
storing information of the compensation from the buyer for the product in a storage.

18. The machine-readable medium of claim 15, wherein the transferring of the commission to the third party comprises crediting an account of the third party with the commission.

19. The machine-readable medium of claim 15, wherein the transferring of the commission to the third party comprises debiting an account of a seller of the product with the commission.

20. The machine-readable medium of claim 15, wherein the buyer information is retrieved from the search query.
